(19) United States
(12) Patent Application Publication
(10) Pub. No.: US 2022/0233894 A1
(43) Pub. Date: Jul. 28, 2022

(54) WEARABLE AIR FILTER SYSTEM

(71) Applicant: Greg Teter, Waipahu, HI (US)

(72) Inventor: Greg Teter, Waipahu, HI (US)

(21) Appl. No.: 17/156,868

(22) Filed: Jan. 25, 2021

(51) Int. Cl. A62B 18/02; A62B 18/08; A62B 18/10

(52) U.S. Cl. CPC A62B 18/02; A62B 18/006; A62B 18/10; A62B 18/082

(57) ABSTRACT

A wearable air filter system, including a mouth covering section, including a body, a fan disposed on at least a portion of a rear of the body to move air from a front of the body to a rear of the body, at least one purge valve angularly disposed on at least a portion of a base of the body to allow the air from the rear of the body to move through the at least one purge valve to the front of the body, such that the at least one purge valve prevents movement of the air from the front of the body through the at least one purge valve to the rear of the body, a first media unit disposed on at least a portion of a first side of the body, a second media unit disposed on at least a portion of a second side of the body opposite with respect to the first side of the body, a microphone disposed within at least a portion of the body to receive at least one external audio input therein, and an external speaker disposed on at least a portion of the body to emit at least one internal audio input therefrom, goggles removably connected to at least a portion of the body to prevent at least one of the air and at least one pathogen from moving therethrough, and a wearable control device connected to the mouth covering section to control operations of the mouth covering section and display a vitals reading thereon.

### BACKGROUND

### 1. Field

The present general inventive concept relates generally to an air filter, and particularly, to a wearable air filter system.

### 2. Description of the Related Art

Many viruses travel through air in aerosol form thus facilitating the spread of harmful diseases. Currently, a worldwide pandemic is underway due to coronavirus disease 2019 (COVID-19). COVID-19 has rapidly changed how people interact in society. In particular, people use a face covering at all times in public places. However, modern face covers (e.g., masks) do not adequately protect individuals from transmission of particles suspended in the air.

Also, the modern face covers are generally worn over a nose and a mouth of a user without providing a seal against a face of the user. Therefore, wearing the face cover still allows the air to pass unfiltered on sides of the mask. Also, the user's eyes have no protection.

Therefore, there is a need for an air filter system that restricts air flow around the nose and/or the mouth of the user, and also protects the eyes.

### SUMMARY

The present general inventive concept provides a wearable air filter system.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a wearable air filter system, including a mouth covering section, including a body, a fan disposed on at least a portion of a rear of the body to move air from a front of the body to a rear of the body, at least one purge valve angularly disposed on at least a portion of a base of the body to allow the air from the rear of the body to move through the at least one purge valve to the front of the body, such that the at least one purge valve prevents movement of the air from the front of the body through the at least one purge valve to the rear of the body, a first media unit disposed on at least a portion of a first side of the body, a second media unit disposed on at least a portion of a second side of the body opposite with respect to the first side of the body, a microphone disposed within at least a portion of the body to receive at least one external audio input therein, and an external speaker disposed on at least a portion of the body to emit at least one internal audio input therefrom, goggles removably connected to at least a portion of the body to prevent at least one of the air and at least one pathogen from moving therethrough, and a wearable control device connected to the mouth covering section to control operations of the mouth covering section and display a vitals reading thereon.

The fan may include a potentiometer to regulate speed of the fan based on a speed of the air moving through the fan.

The wearable air filter system may further include at least one light movably disposed on at least a portion of the front of the body to illuminate a surrounding area of the body.

The first media unit may include an activation button to connect to the fan in response to depressing the activation button a first predetermined number of times, and connect to the at least one light in response to depressing the activation button a second predetermined number of times, a first adjustment knob disposed around a perimeter of the activation button to increase at least one of a rotation speed of the fan and a brightness level of the at least one light in response to moving the first adjustment knob in a first direction, and decrease at least one of the rotation speed of the fan and the brightness level of the at least one light in response to moving the first adjustment knob in a second direction, and a first speaker disposed on at least a portion of the rear of the body to emit the at least one external audio input therefrom.

The second media unit may include a plurality of adjustment buttons to change a current track thereof, a second adjustment knob disposed around a perimeter of the plurality of adjustment buttons, and a second speaker disposed on at least a portion of the rear of the body to emit the at least one external audio input therefrom.

The second adjustment knob may increase a volume level of the first speaker and the second speaker in response to moving the second adjustment knob in the first direction, and decrease the volume level of the first speaker and the second speaker in response to moving the second adjustment knob in the second direction.

The wearable air filter system may further include a camera disposed on at least a portion of the front of the body to record at least one of at least one picture and at least one video thereon.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1A illustrates a front perspective view of a wearable air filter system, according to an exemplary embodiment of the present general inventive concept;

FIG. 1B illustrates a rear perspective view of the wearable air filter system, according to an exemplary embodiment of the present general inventive concept;

FIG. 2 illustrates a side perspective view of the wearable air filter system, according to an exemplary embodiment of the present general inventive concept; and

FIG. 3 illustrates a front view of a wearable control device, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Wearable Air Filter System 100
Mouth Covering Section 110
Body 111
Lip Portion 111a
Side Fastener 111b
Padding 111c
Rear Fastener 111d
Base Filter 111e
Power Source 111f
Fan 112
Purge Valve 113
Light 114
Light Button 115
Communication Unit 115a
First Media Unit 116
Activation Button 116a
First Adjustment Knob 116b
First Speaker 116c
Second Media Unit 117
Adjustment Buttons 117a
Second Adjustment Knob 117b
Second Speaker 117c
Camera 118
Microphone 119
External Speaker 120
Goggles 130
Goggle Body 131
Goggle Fastener 132
Head-Up Display 133
Wearable Control Device 140
Strap 141
Display Unit 142
Input Unit 143
Adjustment Button 143a
Volume Button 143b
Fan Button 143c
Light Button 143d
Phone Button 143e
Potentiometer Slider 143f
Battery Indicator 144
Communication Unit 145

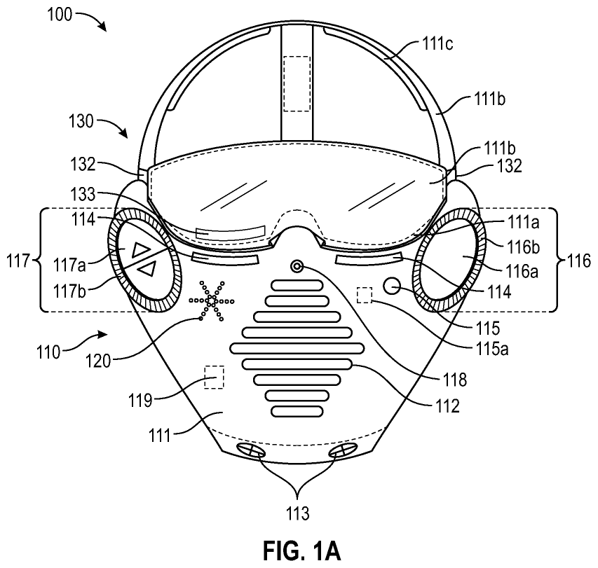

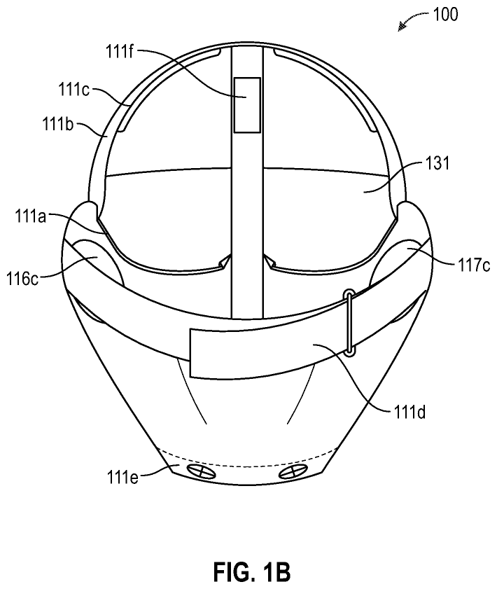

FIG. 1A illustrates a front perspective view of a wearable air filter system 100, according to an exemplary embodiment of the present general inventive concept.

FIG. 1B illustrates a rear perspective view of the wearable air filter system 100, according to an exemplary embodiment of the present general inventive concept.

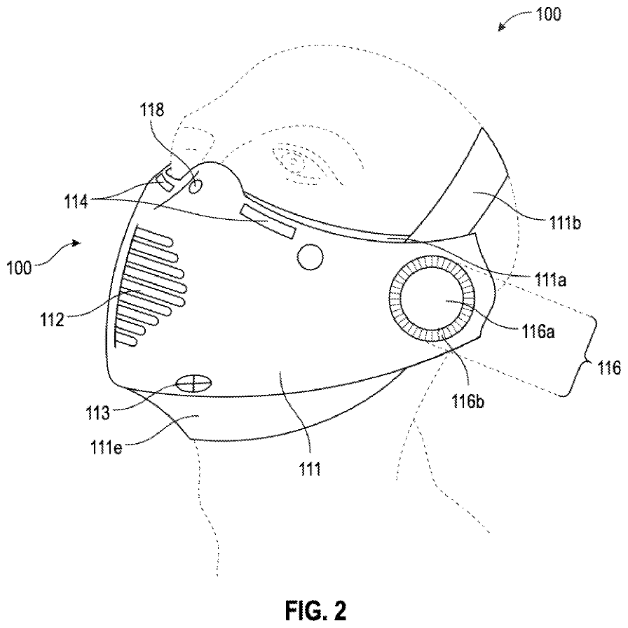

FIG. 2 illustrates a side perspective view of the wearable air filter system 100, according to an exemplary embodiment of the present general inventive concept.

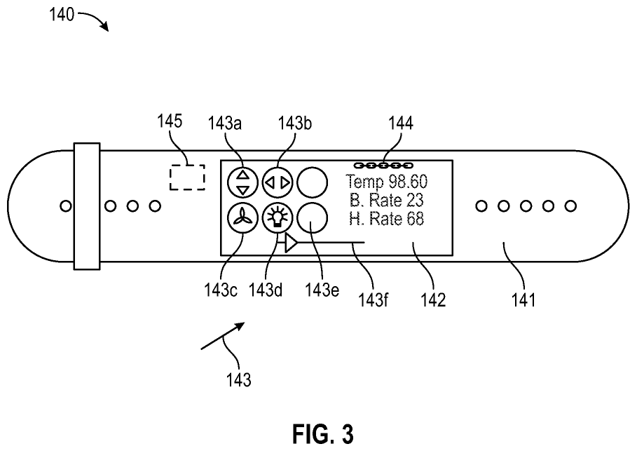

FIG. 3 illustrates a front view of a wearable control device 140, according to an exemplary embodiment of the present general inventive concept.

The wearable air filter system 100 may be constructed from at least one of metal, plastic, wood, glass, silicone, and rubber, etc., but is not limited thereto.

Referring to FIGS. 1A through 3, the wearable air filter system 100 may include a mouth covering section 110, goggles 130, and a wearable control device 140, but is not limited thereto.

The mouth covering section 110 may include a body 111, a fan 112, at least one purge valve 113, at least one light 114, a light button 115, a first media unit 116, a second media unit 117, a camera 118, a microphone 119, and an external speaker 120, but is not limited thereto.

The body 111 may have a predetermined size (e.g., small, medium, large) based on a size of a face of a user. The body 111 may cover at least a portion of the face of the user, such as a nose and/or a mouth of the user.

The body 111 may include a lip portion 111a, a side fastener 111b, a padding 111c, a rear fastener 111d, a base filter 111e, and a power source 111f, but is not limited thereto.

The lip portion 111a may include a magnet and a track, but is not limited thereto.

The lip portion 111a may be angularly disposed away from the body 111 with respect to a direction, such that the lip portion 111a may protrude toward a rear portion of the body 111. The lip portion 111a may provide a seal again the face of the user, such that air remains between the body 111 and the face of the user. Moreover, the body 111 may provide an air-tight seal (i.e. air does not move therethrough) against the face of the user.

The side fastener 111b may include a strap, a string, a rope, a wire, a twine, a clasp, a button, a snap, an adhesive (e.g., tape, glue), a magnet, but is not limited thereto.

The side fastener 111b may be disposed on at least a portion of the body 111. The side fastener 111b may extend away from the body 111 to form a loop, such that the side fastener 111b may wrap around a top portion of a head of the user. As such, the side fastener 111b may prevent the body 111 from falling off the head of the user.

The padding 111c may be disposed on at least a portion of the side fastener 111b. The padding 111c may absorb an impact thereto by an external force and/or an external object. Additionally, the padding 111c may provide comfort to the head of the user during use of the mouther covering section 110.

The rear fastener 111d may include a strap, a string, a rope, a wire, a twine, a clasp, a button, a snap, an adhesive (e.g., tape, glue), a magnet, but is not limited thereto.

The rear fastener 111d may be disposed on at least a portion of the body 111. The rear fastener 111d may extend away from the body 111 to form a loop, such that the rear fastener 111d may wrap around a rear of the head of the user. As such, the rear fastener 111d may prevent the body 111 from falling off the head of the user.

The base filter 111e may be removably disposed on at least a portion of a base of the body 111. The base filter 111e may provide an air-tight seal against a portion of a neck and/or a chin of the user. Moreover, the base filter 111e may prevent at least one pathogen (e.g., bacteria, virus, parasite, fungus) from moving therethrough. Also, the base filter 111e may be removed from the body 111 to be washed and/or replaced.

The power source 111f may include a battery and a solar cell, but is not limited thereto.

Referring again to FIG. 1B, the power source 111f is illustrated to be disposed on at least a portion of the side fastener 111b. However, the power source 111f may be disposed within at least a portion of the body 111.

The fan 112 may include a filter (e.g., a carbon filter) and a potentiometer, but is not limited thereto.

The fan 112 may be disposed on at least a portion of a rear of the body 111. The fan 112 may blow the air from a front of the body 111 toward the rear of the body 111. In other words, the fan 112 may move (i.e. draw) the air from the front of the body 111 into a space between the body 111 and the nose and/or the mouth of the user. Accordingly, the fan 112 may move the air from outside the body 111 to inside the body 111. Moreover, the fan 112 may move (i.e. rotate) based on regulation of speed by the potentiometer. More specifically, the fan 112 may move in response to a speed of the air moving through the fan 112, such as a breathing speed of the user. As such, the potentiometer of the fan 112 may facilitate the air received by the user. Also, the filter of the fan 112 may prevent the at least one pathogen from moving therethrough.

The at least one purge valve 113 may be angularly disposed on at least a portion of the base of the body 111, such that the at least one purge valve 113 may be oriented toward a ground surface while the body 111 is disposed on the face of the user. In other words, the at least one purge valve 113 may be directed toward the ground surface. The at least one purge valve 113 may allow the air to move from the rear of the body 111 through the at least one purge valve 113 toward the front of the body 111. As such, the at least one purge valve 113 may eject the air in only one direction away from the face of the user. In other words, the at least one purge valve 113 may prevent movement of the air from the front of the body 111 through the at least one purge valve 113 to the rear of the body 111.

The at least one light 114 may be movably (i.e. rotatably) disposed on at least a portion of the front of the body 111. The at least one light 114 may illuminate a surrounding area of the body 111.

The light button 115 may include a communication unit 115a, but is not limited thereto.

The light button 115 may be disposed on at least a portion of the front of the body 111. The light button 115 may turn on the at least one light 114 in response to depressing the light button 115 a first time, such that the at least one light 114 may move from retracted in a first position to at least partially extended in a second position. The light button 115 may turn off the at least one light 114 in response to depressing the light button 115 a second time, such that the at least one light 114 may move from extended in the second position to closed in the first position.

The communication unit 115a may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, global positioning system (GPS), Firewire, and Ethernet.

Alternatively, the light button 115 may be depressed for a predetermined amount of time (e.g., five seconds) to allow connection (e.g., pairing via Bluetooth) to an external electronic device (e.g., a cell phone, a music player, a laptop computer, a desktop computer, a tablet computer).

The first media unit 116 may include an activation button 116a, a first adjustment knob 116b, and a first speaker 116c, but is not limited thereto.

The first media unit 116 may be disposed on at least a portion of a first side of the body 111. The activation button 116a may connect to the fan 112 in response to depressing the activation button 116a a first predetermined number of times (e.g., one time) and/or a first predetermined duration of time (e.g., two seconds).

The first adjustment knob 116b may be movably (i.e. rotatably) disposed on at least a portion of the first side of the body 111 around a perimeter of the activation button 116a. Subsequently, the first adjustment knob 116b may increase a rotation speed of the fan 112 in response to moving the first adjustment knob 116b in a first direction (i.e. clockwise) or a second direction (i.e. counterclockwise), and decrease a rotation speed of the fan 112 in response to moving the first adjustment knob 116b in the second direction or the first direction. As such, the first adjustment knob 116b may adjust the potentiometer to control the rotation speed of the fan 112. The potentiometer of the fan 112 may resume operation after a predetermined amount of time (e.g., ten minutes, twenty minutes, thirty minutes, etc.).

The activation button 116a may connect to the at least one light 114 in response to depressing the activation button 116a a second predetermined number of times (e.g., two times) and/or a second predetermined duration of time (e.g., five seconds).

The first adjustment knob 116b may increase a brightness level of the at least one light 114 in response to moving the first adjustment knob 116b in the first direction or the second direction, and decrease the brightness level of the at least one light 114 in response to moving the first adjustment knob 116b in the second direction or the first direction.

The first speaker 116c may be disposed on at least a portion of the rear of the body 111. The first speaker 116c may emit at least one sound from the external electronic device.

The second media unit 117 may include a plurality of adjustment buttons 117a, a second adjustment knob 117b, and a second speaker 117c, but is not limited thereto.

The second media unit 117 may be disposed on at least a portion of a second side of the body 111 opposite with respect to the first side of the body 111. The plurality of adjustment buttons 117a may change a current track thereof from the external electronic device. In other words, a first of the plurality of adjustment buttons 117a may change the current track to a subsequent track, and a second of the plurality of adjustment buttons 117a may change the current track to a previous track.

The second adjustment knob 117b may be movably (i.e. rotatably) disposed on at least a portion of the second side of the body 111 around a perimeter of the plurality of adjustment buttons 117a.

The second speaker 117c may be disposed on at least a portion of the rear of the body 111. The second speaker 117c may emit the at least one sound from the external electronic device.

Moreover, the second adjustment knob 117b may increase a volume level of the first speaker 116c and/or the second speaker 117c in response to moving the second adjustment knob 117b in the first direction or the second direction, and decrease the volume level of the first speaker 116c and/or the second speaker 117c in response to moving the second adjustment knob 117b in the second direction or the first direction.

The camera 118 may include any type of camera known to one of ordinary skill in the art, including, but not limited to, an action camera, an animation camera, an autofocus camera, a box camera, a camcorder, a camera phone, a compact camera, a dashboard camera (i.e., a Dashcam), a digital camera, a field camera, a FIREWIRE camera, a helmet camera, a high-speed camera, an instant camera, a keychain camera, a live-preview digital camera, a movie camera, an omnidirectional camera, a pinhole camera, a pocket camera, a pocket video camera, a rangefinder camera, a reflex camera, a remote camera, a stereo camera, a still camera, a still video camera, a subminiature camera, a system camera, a thermal imaging camera, a thermographic camera, a traffic camera, a traffic enforcement camera, a twin-lens reflex camera, a video camera, a view camera, a webcam, a WRIGHT camera, a ZENITH camera, a zoom-lens reflex camera.

The camera 118 may further include a storage unit, such as a random access memory (RAM), a read-only memory (ROM), a hard disk, a flash drive, a database connected to the Internet, cloud-based storage, Internet-based storage, or any other type of storage unit.

The camera 118 may be disposed on at least a portion of the front of the body 111, such that the camera 118 may be flush with the body 111. The camera 118 may record at least one picture and/or at least one video thereon.

The microphone 119 may be disposed within at least a portion of the body 111. The microphone 119 may receive at least one external audio input therein. Moreover, the microphone 119 may send the at least one external audio input (e.g., a voice of another person, a noise) to the first speaker 116c and/or the second speaker 117c. As such, the microphone 119, the first speaker 116c, and/or the second speaker 117c may facilitate hearing of the at least one external audio input.

The external speaker 120 may be disposed on at least a portion of the body 111. The external speaker 120 may emit at least one internal audio input therefrom. Additionally, the external speaker 120 may amplify a volume level of the at least one internal audio input, such that a sound from the user (e.g., a voice of the user) may be emitted from the external speaker 120.

The power source 111f may provide power to the fan 112, the at least one light 114, the light button 115, the communication unit 115a, the first media unit 116, the second media unit 117, the camera 118, the microphone 119, and/or the external speaker 120.

The goggles 130 may include a goggle body 131, a goggle fastener 132, and a head-up display (HUD) 133, but is not limited thereto.

The goggle body 131 may be removably connected to at least a portion of the lip portion 111a. More specifically, the goggle body 131 may removably connected to the magnet of the lip portion 111a and/or a track of the lip portion 111a. As such, the magnet and/or the track of the lip portion 111a may prevent the goggle body 131 from moving away (e.g., falling off) from the lip portion 111a. Also, the goggle body 131 may cover eyes of the user, such that the goggle body 131 may protect the eyes of the user, such that the goggle body 131 may prevent the air and/or the at least one pathogen from moving therethrough.

The goggle fastener 132 may include a strap, a string, a rope, a wire, a twine, a clasp, a button, a snap, an adhesive (e.g., tape, glue), a magnet, but is not limited thereto.

The goggle fastener 132 may be disposed on at least a portion of the goggle body 131. The goggle fastener 132 may extend away from the goggle body 131 to form a loop, such that the goggle fastener 132 may wrap around the rear of the head of the user. As such, the goggle fastener 132 may prevent the goggle body 131 from falling off the head of the user.

The HUD 133 may include a plasma screen, an LCD screen, a light emitting diode (LED) screen, an organic LED (OLED) screen, a computer monitor, a hologram output unit, a sound outputting unit, or any other type of device that visually or aurally displays data.

The HUD 133 may be projected on an inner surface of the goggle body 131. Accordingly, the HUD 133 may appear as an illuminated image (e.g., a picture, an image, a letter, a number, a symbol, a word, etc.) on the inner surface of the goggle body 131. For example, the HUD 133 may display a vitals reading of the user, such as a temperature level, a blood pressure level, and/or a heart rate.

The wearable control device 140 may include a strap 141, a display unit 142, an input unit 143, a battery indicator 144, and a communication unit 145, but is not limited thereto.

The strap 141 may connect to at least a portion of a body of the user, such as an arm and/or a leg of the user. In other words, the strap 141 may facilitate wearing thereof.

The display unit 142 may include a plasma screen, an LCD screen, a light emitting diode (LED) screen, an organic LED (OLED) screen, a computer monitor, a hologram output unit, a sound outputting unit, or any other type of device that visually or aurally displays data.

The display unit 142 may be disposed on at least a portion of the strap 141. The display unit 142 may display the vitals reading of the user.

The input unit 143 may include an adjustment button 143a, a volume button 143b, a fan button 143c, a light button 143d, a phone button 143e, and a potentiometer slider 143f, but is not limited thereto.

The input unit 143 may be disposed on at least a portion of the display unit 142. The adjustment button 143a may change the current track from the external electronic device similar to the plurality of adjustment buttons 117a described above. In other words, the plurality of adjustment button 143a may change the current track to a subsequent track in response to a first depress of the adjustment button 143a, and change the current track to a previous track in response to a second depress of the adjustment button 143a, such that the second depress is two depresses within a second.

The volume button 143b may increase the volume level of the first speaker 116c and/or the second speaker 117c in response to a first depress of the volume button 143b, and decrease the volume level of the first speaker 116c and/or the second speaker 117c in response to a second depress of the volume button 143b, such that the second depress is two depresses within a second.

The fan button 143c may turn on the fan 112 in response to depressing the fan button 143c a first time, and turn off the fan 112 in response to depressing the fan button 143c a second time.

The light button 143d may turn on the at least one light 114 in response to depressing the light button 143d a first time, and turn off the at least one light 114 in response to depressing the light button 143d a second time.

The phone button 143e may pick up a call from the external electronic device to be received on the first speaker 116c and/or the second speaker 117c in response to depressing the phone button 143e a first time, and disconnect the call from the external electronic device in response to depressing the phone button 143e a second time.

The potentiometer slider 143f may increase the rotation speed of the fan 112 in response to moving the potentiometer slider 143f in a first lateral direction (i.e. right) or a second direction (i.e. left), and decrease the rotation speed of the fan 112 in response to moving the potentiometer slider 143f in the second direction or the first direction. As such, the potentiometer slider 143f may adjust the potentiometer to control the rotation speed of the fan 112. The potentiometer of the fan 112 may resume operation after a predetermined amount of time (e.g., ten minutes, twenty minutes, thirty minutes, etc.).

The battery indicator 144 may include a battery, but is not limited thereto.

The battery indicator 144 may indicate a current battery level of the battery to provide power to the wearable control device 140.

The communication unit 145 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, global positioning system (GPS), Firewire, and Ethernet.

The communication unit 145 may be disposed within at least a portion of the strap 141 and connected to the display unit 142 and/or the input unit 143. The communication unit 145 may receive at least one signal from the communication unit 115a and/or transmit the at least one signal to the communication unit 115a. In other words, the communication unit 145 may facilitate communications with the mouth covering section 110, such that the wearable control device 140 may control operations of the mouth covering section 110.

Therefore, the wearable air filter system 100 may regulate air flow around the nose and/or the mouth of the user using the fan 112 and/or the at least one purge valve 113. Also, the wearable air filter system 100 may facilitate listening to music and/or the another person by the user due to the first speaker 116c and/or the second speaker 117c.

The present general inventive concept may include a wearable air filter system 100, including a mouth covering section 110, including a body 111, a fan 112 disposed on at least a portion of a rear of the body 111 to move air from a front of the body 111 to a rear of the body 111, at least one purge valve 113 angularly disposed on at least a portion of a base of the body 111 to allow the air from the rear of the body 111 to move through the at least one purge valve 113 to the front of the body 111, such that the at least one purge valve 113 prevents movement of the air from the front of the body 111 through the at least one purge valve 113 to the rear of the body 111, a first media unit 116 disposed on at least a portion of a first side of the body 111, a second media unit 117 disposed on at least a portion of a second side of the body 111 opposite with respect to the first side of the body 111, a microphone 119 disposed within at least a portion of the body 111 to receive at least one external audio input therein, and an external speaker 120 disposed on at least a portion of the body 111 to emit at least one internal audio input therefrom, goggles 130 removably connected to at least a portion of the body 111 to prevent at least one of the air and at least one pathogen from moving therethrough, and a wearable control device 140 connected to the mouth covering section 110 to control operations of the mouth covering section 110 and display a vitals reading thereon.

The fan 112 may include a potentiometer to regulate speed of the fan 112 based on a speed of the air moving through the fan 112.

The wearable air filter system 100 may further include at least one light 114 movably disposed on at least a portion of the front of the body 111 to illuminate a surrounding area of the body 111.

The first media unit 116 may include an activation button 116a to connect to the fan 112 in response to depressing the activation button 116a a first predetermined number of times, and connect to the at least one light 114 in response to depressing the activation button 116a a second predetermined number of times, a first adjustment knob 116b disposed around a perimeter of the activation button 116a to increase at least one of a rotation speed of the fan 112 and a brightness level of the at least one light 114 in response to moving the first adjustment knob 116b in a first direction, and decrease at least one of the rotation speed of the fan 112 and the brightness level of the at least one light 114 in response to moving the first adjustment knob 116b in a second direction, and a first speaker 116c disposed on at least a portion of the rear of the body 111 to emit the at least one external audio input therefrom.

The second media unit 117 may include a plurality of adjustment buttons 117a to change a current track thereof, a second adjustment knob 117b disposed around a perimeter of the plurality of adjustment buttons 117a, and a second speaker 117c disposed on at least a portion of the rear of the body 111 to emit the at least one external audio input therefrom.

The second adjustment knob 117b may increase a volume level of the first speaker 116c and the second speaker 117c in response to moving the second adjustment knob 117b in the first direction, and decrease the volume level of the first speaker 116c and the second speaker 117c in response to moving the second adjustment knob 117b in the second direction.

The wearable air filter system 100 may further include a camera 118 disposed on at least a portion of the front of the body 111 to record at least one of at least one picture and at least one video thereon.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A wearable air filter system, comprising:
a mouth covering section, comprising:
a body,
a fan disposed on at least a portion of a rear of the body to move air from a front of the body to a rear of the body,
at least one purge valve angularly disposed on at least a portion of a base of the body to allow the air from the rear of the body to move through the at least one purge valve to the front of the body, such that the at least one purge valve prevents movement of the air from the front of the body through the at least one purge valve to the rear of the body,
a first media unit disposed on at least a portion of a first side of the body,
a second media unit disposed on at least a portion of a second side of the body opposite with respect to the first side of the body,
a microphone disposed within at least a portion of the body to receive at least one external audio input therein, and
an external speaker disposed on at least a portion of the body to emit at least one internal audio input therefrom;
goggles removably connected to at least a portion of the body to prevent at least one of the air and at least one pathogen from moving therethrough; and
a wearable control device connected to the mouth covering section to control operations of the mouth covering section and display a vitals reading thereon.

2. The wearable air filter system of claim 1, wherein the fan comprises:
a potentiometer to regulate speed of the fan based on a speed of the air moving through the fan.

3. The wearable air filter system of claim 1, further comprising:
at least one light movably disposed on at least a portion of the front of the body to illuminate a surrounding area of the body.

4. The wearable air filter system of claim 3, wherein the first media unit comprises:
an activation button to connect to the fan in response to depressing the activation button a first predetermined number of times, and connect to the at least one light in response to depressing the activation button a second predetermined number of times;
a first adjustment knob disposed around a perimeter of the activation button to increase at least one of a rotation speed of the fan and a brightness level of the at least one light in response to moving the first adjustment knob in a first direction, and decrease at least one of the rotation speed of the fan and the brightness level of the at least one light in response to moving the first adjustment knob in a second direction; and
a first speaker disposed on at least a portion of the rear of the body to emit the at least one external audio input therefrom.

5. The wearable air filter system of claim 4, wherein the second media unit comprises:
a plurality of adjustment buttons to change a current track thereof;
a second adjustment knob disposed around a perimeter of the plurality of adjustment buttons; and
a second speaker disposed on at least a portion of the rear of the body to emit the at least one external audio input therefrom.

6. The wearable air filter system of claim 5, wherein the second adjustment knob increases a volume level of the first speaker and the second speaker in response to moving the second adjustment knob in the first direction, and decrease the volume level of the first speaker and the second speaker in response to moving the second adjustment knob in the second direction.

7. The wearable air filter system of claim 1, further comprising:
a camera disposed on at least a portion of the front of the body to record at least one of at least one picture and at least one video thereon.
